(19) United States
(12) Patent Application Publication
(10) Pub. No.: US 2014/0179283 A1
(43) Pub. Date: Jun. 26, 2014

(54) PORTABLE TERMINAL AND METHOD FOR PROVIDING INFORMATION DURING A CALL

(71) Applicant: PANTECH CO., LTD., Seoul (KR)

(72) Inventors: Hoe Kyung KWON, Seoul (KR); Jun Wan CHOI, Seoul (KR); Seul Ki HONG, Seoul (KR)

(73) Assignee: PANTECH CO., LTD., Seoul (KR)

(21) Appl. No.: 14/108,942

(22) Filed: Dec. 17, 2013

(30) Foreign Application Priority Data
Dec. 20, 2012 (KR) 10-2012-0149803

(51) Int. Cl. H04M 3/493; H04W 4/16

(52) U.S. Cl. CPC H04M 3/493; H04W 4/16
USPC 455/414.1

(57) ABSTRACT

A portable terminal and a method for providing information includes establishing a connection with an automated response system (ARS); receiving, from the ARS, a sound; parsing the received sound into one or more blocks of data; identifying a number value and a word from a block of data; generating mapping data by mapping a number key of the portable terminal to the identified word based on the identified number value; and outputting the mapped word with the corresponding number key on the portable terminal according to the mapping data.

### CROSS-REFERENCE TO RELATED APPLICATION

This application claims priority from and the benefit under 35 U.S.C. §119(a) of Korean Patent Application No. 10-2012-0149803, filed on Dec. 20, 2012, the entire disclosure of which is incorporated by reference for all purposes.

### BACKGROUND

1. Field

The following disclosure relates to a portable terminal and a method for displaying information received during a call.

2. Discussion of the Background

When calling an automated response system (ARS), a user generally listens to a is recorded mechanical sound or a pre-recorded message, which provides a verbal listing of various menu options. The user may need to listen to the list of menu options, which are matched to a button of a telephone (e.g., number key 1 for movies) and remember the list of menu options corresponding to each button. The user may select a number key corresponding to the desired menu option to obtain desired information.

To acquire such desired information, the user is required to remember a list of menu options including desired information and a button corresponding to the respective menu option. The user may have to listen to the entire list of menu options again when the user is unable to remember the menu options and/or the corresponding buttons.

### SUMMARY

Exemplary embodiments of the present invention provide a portable terminal and a method for displaying information received during a call.

Additional features of the invention will be set forth in the description which follows, and in part will be apparent from the description, or may be learned by practice of the invention.

Exemplary embodiments of the present invention provide a method for providing information on a portable terminal including establishing a connection with an automated response system (ARS); receiving, from the ARS, a sound; parsing the received sound into one or more blocks of data; identifying a number value and a word from a block of data; generating mapping data by mapping a number key of the portable terminal to the identified word based on the identified number value; and outputting the mapped word with the corresponding number key on the portable terminal according to the mapping data.

Exemplary embodiments of the present invention provide a portable terminal including a controller to establish a connection with an automated response system (ARS), and to receive a sound from the ARS; a speech processing unit to parse the sound into one or more blocks of data, to identify a number value and a word from a block of data, and to generate mapping data by mapping a number key of the portable terminal to the identified word based on the identified number value; and a content output unit to output the mapped word with the corresponding number key according to the mapping data.

Exemplary embodiments of the present invention provide a method for providing convenience information on a portable terminal including establishing a connection with an automated response system (ARS) having a telephone number; determining whether a data object corresponding to the telephone number is stored in a database; and loading the data object for outputting a text of a menu option mapped to a number key of the portable terminal, in which the data object includes mapping information of the menu option provided in the ARS with the number key.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a block diagram illustrating a portable terminal according to an exemplary embodiment of the present invention.

FIG. 2 is a block diagram illustrating a portable terminal according to an exemplary embodiment of the present invention.

FIG. 3 illustrates a configuration of a controller of a portable terminal according to an exemplary embodiment of the present invention.

FIG. 4 illustrates a configuration of a speech processing unit of a portable terminal according to an exemplary embodiment of the present invention.

FIG. 5 illustrates a configuration of a content output unit of a portable terminal according to an exemplary embodiment of the present invention.

FIG. 6 illustrates a format of a data object according to an exemplary embodiment of the present invention.

FIG. 7 illustrates information mapped to a number key displayed on a dial interface of a portable terminal according to an exemplary embodiment of the present invention.

FIG. 8 illustrates a menu selection history of previous selections made during a call according to an exemplary embodiment of the present invention.

FIG. 9 illustrates a portable terminal receiving a sound and transmitting corresponding information according to an exemplary embodiment of the present invention.

FIG. 10 is a flowchart illustrating a method for providing convenience information during a call on a portable terminal according to an exemplary embodiment of the present invention.

FIG. 11 is a flowchart illustrating a method for providing convenience information during a call on a portable terminal according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular exemplary embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. is does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

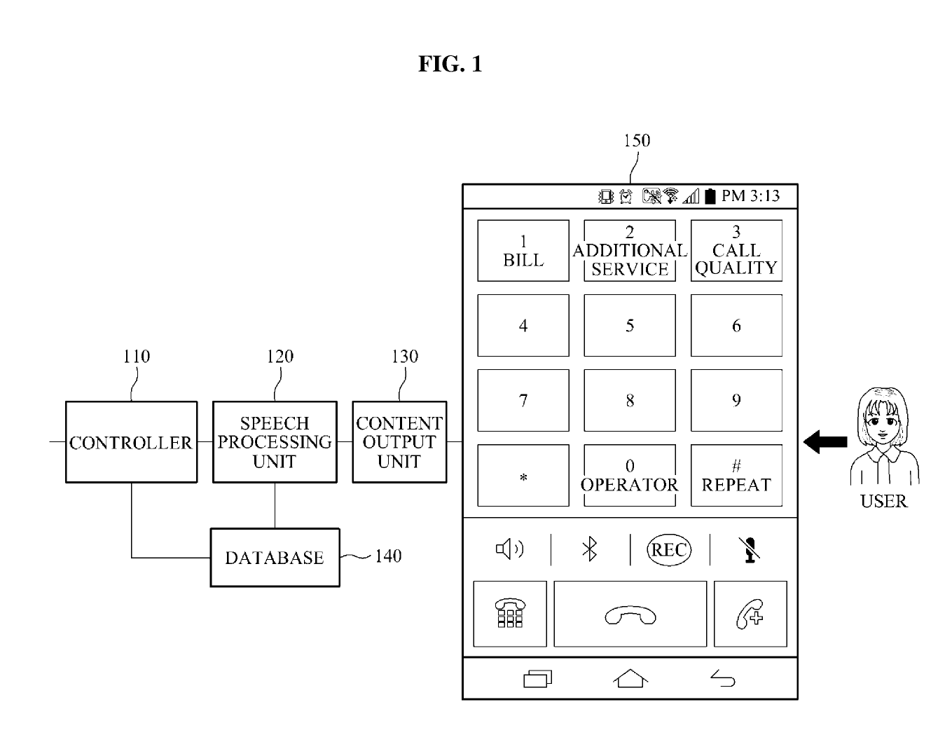

FIG. 1 is a block diagram illustrating a portable terminal according to an exemplary embodiment of the present invention.

Referring to FIG. 1, the portable terminal includes a controller 110, a speech processing unit 120, a content output unit 130, and a database 140.

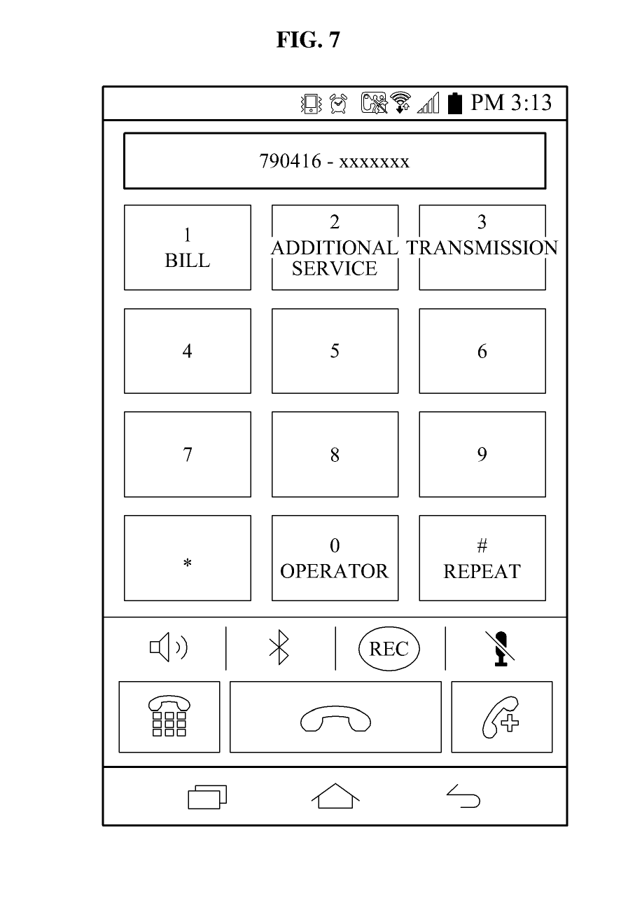

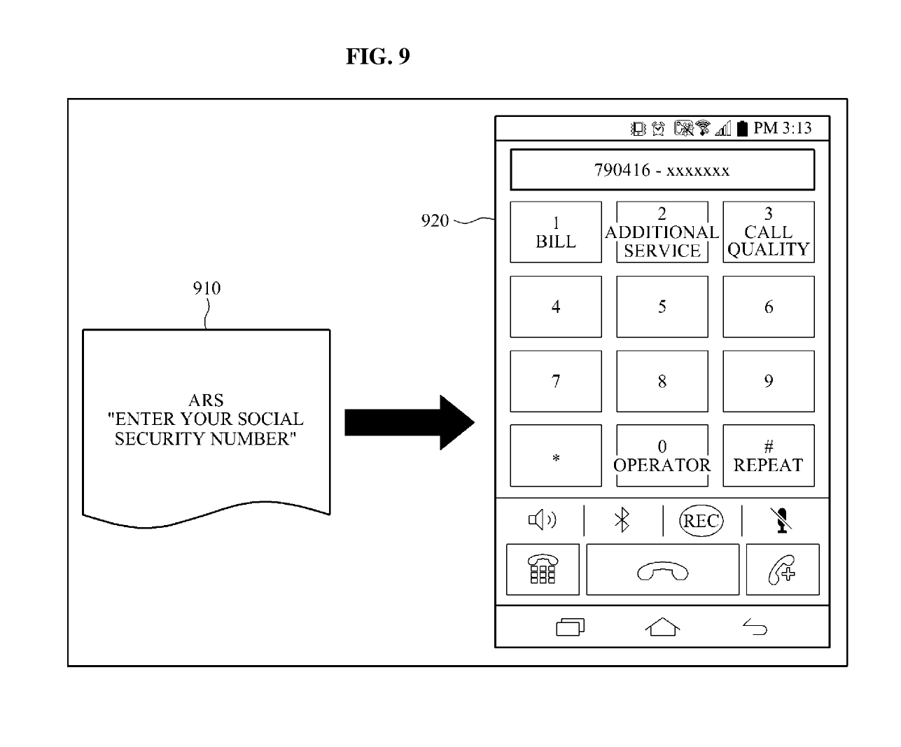

When a call from the portable terminal is connected to a computerized recipient, such as an automated response system (ARS) or other similar systems, and a sound is outputted to be perceived by a user, the controller 110 may activate the speech processing unit 120 and the content output unit 130. For example, the sound, which may be provided in an analog or a digital form, may read out various menu options with corresponding number keys users may press to select the respective menu option. The sound may be a mechanical sound. In more detail, the content output unit 130 may output or display a dial screen onto a screen of the portable terminal. Further, the content output unit 130 may display the dial screen simultaneously with activation of the speech processing unit 120. However, aspects of the invention are not limited thereto, such that the dial screen may be displayed before or after the is activation of the speech processing unit 120. The speech processing unit 120 may convert the sound received by the portable terminal into digital data, and map a number of the dial screen to a word or phrase identified from the digital data for generating mapping data. The content output unit 130 may output or display a number key and the mapped word or phrase on the dial screen using the mapping data. For example, the mapped word or phrase may be displayed with or within a reference proximity of the corresponding number key of a keypad of the portable terminal (e.g., FIG. 7 and FIG. 9).

The content output unit 130 may automatically output or display the dial screen on the screen of the portable terminal without receiving an input from a user when the speech processing unit 120 is activated.

The content output unit 130 may output or display the word identified from the sound, which may be mapped to a number key, on the dial screen on the screen of the portable terminal at different times. More specifically, the content output unit 130 may display the word associated with the number on the dial screen according to the order of menu options or listing corresponding to the received sound. However, aspects of the invention are not limited thereto, such that the words mapped to the number may be displayed on the dial screen simultaneously or near simultaneously, for example, displayed from a memory or database.

For example, when a user places the portable terminal adjacent to an ear of the user, and then moves the portable terminal apart by a predetermined distance to view the display screen of the portable terminal, the content output unit 130 may output or display the word mapped to the number on the dial screen when the portable terminal is moved by the predetermined distance. For example, the controller 110 may estimate a distance between the ear of the user and the portable terminal based on brightness of light received by a sensor, such as a is luminance sensor, for example. The speech processing unit 120 may parse the sound, which may be perceived by the user while the portable terminal is placed adjacent to the ear of the user, into one or more blocks of data and map a number to a word or phrase identified in each block for generating the mapping data. Some or all number keys on the dial screen, which may correspond to the identified numbers in the one or more blocks of data, and some or all words mapped to the respective number keys may be displayed on the screen of the portable terminal.

Further, the content output unit 130 may output or display the words mapped to the number keys on the screen of the portable terminal in order of parsing by the speech processing unit 120.

Further, the content output unit 130 may output or display only the numbers on the dial screen until the speech processing unit 120 completes parsing, and then output some or all words mapped to the numbers on the screen of the portable terminal after parsing is completed. However, aspects of the invention are not limited thereto, such that the mapped words may be displayed on the screen of the portable terminal while parsing is being performed.

The speech processing unit 120 may receive and parse an analog sound. For example, when the analog sound is received, the speech processing unit 120 may parse the sound into one or more blocks of data. Here, a block of data may be set based on a segment of the sound. When the sound is not successively received during a preset time, such a section may be defined as a single block. The speech processing unit 120 may convert parsed blocks of data into digital data. The speech processing unit 120 may convert the digital data into a number, a word, or a phrase.

The speech processing unit 120 may identify a number value from the parsed data, which may match with a number on a dial pad 150. For example, the dial pad 150 may is include number keys, such as 0 to 9, * and #. Further, the speech processing unit 120 may identify a number value, a word or a phrase in the block via parsing. The speech processing unit 120 may map the identified number value to the identified word in the block. The speech processing unit 120 may generate mapping data by mapping a number on the dial pad 150, which may correspond to the identified number value from the parsed data, to a word or phrase identified in the parsed block.

Further, the controller 110 may store the mapping information associated with a particular ARS associated with a phone number in database 140. Accordingly, when a user calls the phone number associated with the ARS again, the stored mapping information may be displayed on the dial pad even before the sound is processed or received. Further, if the menu options in the ARS become changed, the stored mapping information may be updated with the new information. More specifically, the controller 110 may activate the speech processing unit 120 when a call is connected, and update the stored mapping information stored in the database 140 with the changed information, such as new menu options, for a phone number associated with an ARS.

Further, the controller 110 may verify or determine whether the portable terminal is attempting to make a call to an ARS for which its mapping information is already stored, and not activate the speech processing unit 120 if such information is stored. The phone number of the ARS, as well as corresponding mapping information, of which the portable terminal attempts to connect to may be stored in the database 140.

When a phone number is inputted by the user to make a call to a target recipient, the controller 110 may verify or determine whether the inputted phone number is stored in the database 140. When the phone number is verified or determined to be stored in the database 140, the controller 110 may transmit the data object, which may include the mapping data associated with the respective phone number, stored in the database 140 to the content output unit 130, the speech processing unit 120 may not be activated or be inactivated during the call. The mapping data associated with a corresponding telephone number may be stored as a data object.

For example, when the phone number to which a call is being made corresponds to a phone number of an ARS stored in the database 140, the controller 110 may load a data object corresponding to the respective the phone number from the database 140. The data object may have the respective phone number as its object identifier (ID). Here, the data object may include mapping data. The mapping data may include menu information or options of the ARS mapped one or more numbers on the dial pad 150.

Further, when the inputted phone number is determined not stored in the database 140 the controller 110 may activate the speech processing unit 120 during or before a call with the target recipient when a call to the target recipient having the phone number inputted is connected or is in the process of being connected.

The content output unit 130 may retrieve a number value, which may correspond to a number key on a dial pad or screen, mapped onto an identified word or phrase from the mapping data and output the identified word or phrase along with a number key on the dial to screen as a mapped number key (e.g., number keys 1-3 of FIG. 7).

The content output unit 130 may generate a text dial view to output a word mapped to a number key on the dial screen. The text dial view refers to a layer in which a word mapped to a number key is displayed in an area where a number corresponding to the number key of the dial screen is displayed. The content output unit 130 may synthesize a layer in which is a number key is displayed with the text dial view so that the number and the word are displayed together on the dial screen. For example, on the dial pad 150, number key 1 is displayed with “bill,” number key 2 is displayed with “additional service,” number key 3 is displayed with “call quality,” number key 0 is displayed with “operator,” and number key # is displayed with “repeat.”

Further, the content output unit 130 may output the mapped word along with the number key directly on the dial screen without generating the text dial view and synthesizing the layers.

The controller 110 may be responsible for overall control of the portable terminal providing the convenience information and perform one or more operations of the speech processing unit 120 and the content output unit 130. FIG. 1 shows the controller 110, the speech processing unit 120, and the content output unit 130 separately, which is for description to distinguish the operations thereof. However, aspects of the invention are not limited thereto, such that two or more of these units may be integrated together as a single unit. Thus, in practical products, the controller 110 may be configured to perform some or all operations of the foregoing components or only a portion of the operations thereof.

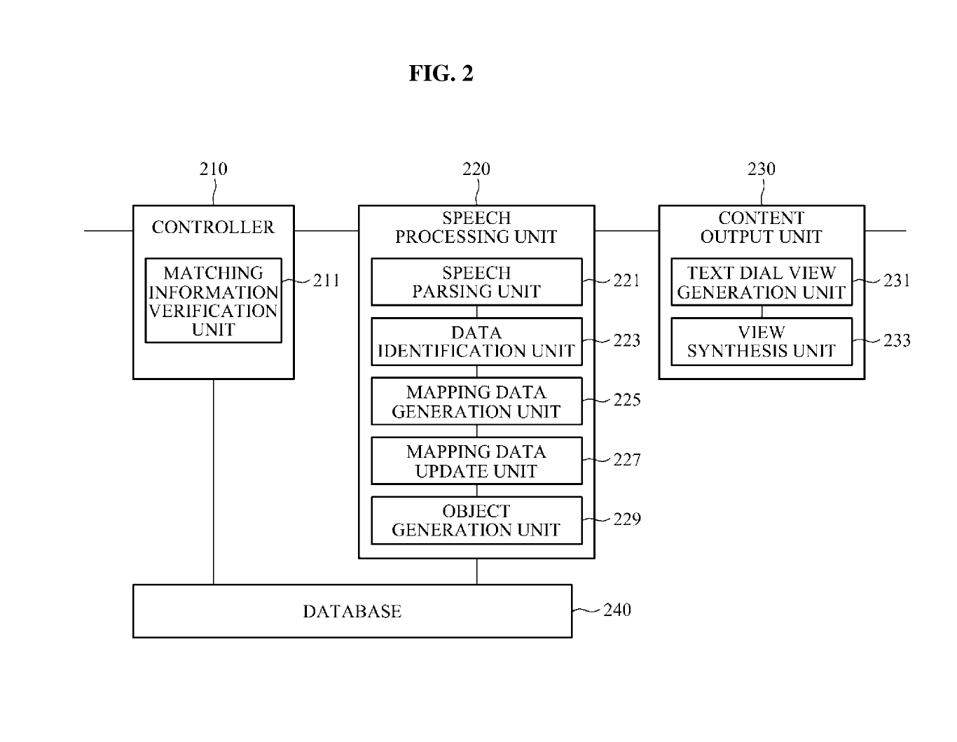

FIG. 2 is a block diagram illustrating a portable terminal according to an exemplary embodiment of the present invention.

Referring to FIG. 2, a portable terminal includes a controller 210, a speech processing unit 220, a content output unit 230, and a database 240.

The controller 210 may determine whether a call connection operation of the portable terminal is activated. When the call connection operation is determined to be activated, the controller 210 may operate a matching information verification unit 211. The controller 210 may include the matching information verification unit 211.

The matching information verification unit 211 may verify or determine whether a telephone number to call or being connected to is stored in the database 240. When the telephone number to call to is verified or determined to be stored in the database 240, the matching information verification unit 211 may receive or retrieve a data object, which may include mapping information associated with a system corresponding to the respective telephone number from the database 240. The data object may have an identifier corresponding to the dialed telephone number. Further, the telephone number may be used as identification information or an identifier for the data object. The matching information verification unit 211 may transmit the received data object to the content output unit 230.

When the call is connected and a sound is received or perceived by the user, the controller 210 may activate the speech processing unit 220 and the content output unit 230. More specifically, the content output unit 230 may output or display a dial screen on a screen of the portable terminal. Further, the content output unit 230 may display the dial screen simultaneously with activation of the speech processing unit 220. However, aspects of the invention are not limited thereto, such that the dial screen may be displayed before or after the activation of the speech processing unit 220. The speech processing unit 220 may convert the sound received by the portable terminal into digital data, and map a number of the dial screen to a word or phrase identified from the digital data for generating mapping data. The content output unit 230 may output or display a number key and the mapped word or phrase on the dial screen, using the mapping data. For example, the mapped word or phrase may be displayed with or within a reference proximity of the corresponding number key (e.g., FIG. 7 and FIG. 9).

The content output unit 230 may automatically output or display the dial screen on the screen of the portable terminal without receiving an input from a user when the speech processing unit 220 is activated.

The content output unit 230 may output or display the word mapped to the number key on the dial screen on the screen of the portable terminal at different times. More specifically, the content output unit 130 may display the word associated with the number key according to the order of menu options or listing corresponding to the received sound. However, aspects of the invention are not limited thereto, such that the words mapped to the number keys may be displayed on the dial screen simultaneously.

For example, when a user places the portable terminal adjacent to an ear of the user, and then moves the portable terminal apart by a predetermined distance to view the display screen of the portable terminal, the content output unit 230 may output or display the word mapped to the number onto the dial screen when the portable terminal is moved by the predetermined distance. For example, the controller 210 may estimate a distance between the ear of the user and the portable terminal based on brightness of light received by a sensor, such as a luminance sensor, for example. The speech processing unit 220 may parse the sound, which may be perceived by the user while the portable terminal is placed adjacent to the ear of the user, into blocks of data and map a number key to a word or phrase identified in one or more blocks of data for generating the mapping data. Some or all number keys on the dial screen and some or all words mapped to the respective numbers may be displayed on the screen of the portable terminal.

Further, the content output unit 230 may output or display the words mapped to the numbers onto the screen of the portable terminal in order of parsing by the speech processing unit 220.

Further, the content output unit 230 may output or display only the numbers on the dial screen until the speech processing unit 220 completes parsing, and then output some or all words mapped to the numbers on the screen of the portable terminal after parsing is completed. However, aspects of the invention are not limited thereto, such that the mapped words may be displayed on the screen of the portable terminal while parsing is being performed.

Further, the controller 210 may store the mapping information associated with a phone number of a particular ARS. Accordingly, when a user calls the phone number associated with the ARS again, the stored mapping information may be displayed on a dial pad before the sound from the ARS is processed. Further, if the menu options in the ARS become changed, the stored mapping information may be updated with the new information. More specifically, the controller 210 may activate the speech processing unit 220 when a call is connected, and update the stored mapping information or a data object stored in the database 240 with the changed information, such as new menu options, for a phone number associated with an ARS.

Further, when the telephone number to call is not stored in the database 240, the controller 210 may activate the speech processing unit 220.

The speech processing unit 220 includes a speech parsing unit 221, a data identification unit 223, a mapping data generation unit 225, a mapping data update unit 227, and an object generation unit 229.

The speech parsing unit 221 may parse the received or perceived sound into blocks of data. More specifically, the speech parsing unit 221 may parse the received or perceived sound based on segmentation of the received sound for generating blocks of data.

The speech parsing unit 221 may parse the received sound into one or more blocks of data. For example, when an analog sound is provided from an ARS system, it may be unclear whether a particular number value associated with a menu option comes before or after recitation word portion of the menu option in the sound based on a service of the ARS system. Thus, the speech parsing unit 221 may parse the sound into blocks of data, defining each section having a pause of a reference duration as a single block. For example, when an audio signal of “ABC customer service, press 1 for call service, press 2 for additional service, . . . ” is received as the sound, the speech parsing unit 221 may parse the sound such that “ABC customer service” is a first block, “press 1 for call service” is a second block, and “press 2 for additional service” is a third block.

The data identification unit 223 may identify a number value and a word from a parsed block. The data identification unit 223 may parse the parsed block again, thereby identifying a number value and a word to be mapped to a number key. For example, number 1, and word of “call service” from the second block may be identified for mapping to a number key 1 on a dial screen. Parsing the number value and the word may be performed based on preset number data and preset word data.

The data identification unit 223 may classify block data in which a number value is not identified as irrelevant data, and classify block data in which a number is identified as relevant data. The data object may not include the block data classified as irrelevant data but include the block data classified as relevant data. For example, the data identification unit 223 may classify the first block as irrelevant data since a number value is not identified from the parsed first block, which includes a sound-bite reciting “ABC customer service.” Also, the data identification unit 223 may classify the second block as relevant data since a number is identified in the parsed second block, which includes sound-bite reciting “press 1 for call service.”

The mapping data generation unit 225 may map a number value included in the block data to a word or phrase identified in the same block to generate mapping data. The mapping data generation unit 225 may map the words or phrases parsed from block data to the number values and/or number keys of a dial interface. For example, number 1 in the second block may be mapped onto two words, “call service,” and number 2 in the third block may be mapped onto two words, “additional service.”

Further, the controller 110 may store the mapping information associated with a particular ARS associated with a phone number. Accordingly, when a user calls the phone number associated with the ARS again, the stored mapping information may be displayed on the dial pad 150 even before sound from the ARS is received or processed. Further, if the menu options in the ARS become changed, the stored mapping information may be updated with the changed information. More specifically, when the mapping data is verified or determined, by the matching information verification unit 211, to be stored in the database 240 with reference to the corresponding phone number as an object identifier (ID), the mapping data update unit 227 may update changed information, which may include mapped numbers and/or words in the mapping data. The mapping data may be identified based on an identification result of the object ID by the data identification unit 223. For example, when a word mapped to a number value is changed, the mapping data update unit 227 may update the mapping data or relationship between the number value and the changed word. When the data identification unit 223 identifies that stored mapping data includes words or phrase of “call service” is mapped to number 1, which is changed to words or phrase of “additional service,” the mapping data update unit 227 may update the mapping data by changing word or words of “call” or “call service” mapped to number 1 to word or words of “additional” or “additional service”.

The object generation unit 229 may generate a data object including mapping data by an object ID. The data object may be formed of a combination of an object ID and mapping data. The data object may be identified as the object ID, which may be, for example, a phone number. However, aspects of the invention are not limited thereto, such that the object ID may correspond to a randomly generated number, a sequential number, and the like. The mapping data may include, without limitation, a number on the dial pad and at least one word mapped onto the number.

The data object has a format including an object ID field, which may include an object ID, and a mapping data field, which may include the mapping data.

The content output unit 230 may retrieve a number value mapped to a word identified from the mapping data and output or display the identified word along with a number key on the dial screen as a mapped number key.

The content output unit 230 may include a text dial view generation unit 231 and a view synthesis unit 233.

The text dial view generation unit 231 may generate a text dial view such that the word or phrase identified by the data identification unit 223 is displayed on the number key on the dial screen. The text dial view may refer to a layer in which a word or phrase is displayed in or near an area where a number key of the dial screen is displayed. The text dial view and the dial screen may be synthesized such that both the number key and the corresponding word are displayed together. However, aspects of the invention are not limited thereto, such that the number key of the dial pad and the mapped word or phrase may be displayed in various ways. For example, the word or phrase may be overlaid over the corresponding number key on the dial screen such that the number key may be transparent or vice-versa.

The view synthesis unit 233 may synthesize the layer in which the dial screen is displayed and the text dial view. The content output unit 230 may output or display a synthesized screen of the dial screen and the text dial view on a display of the portable terminal.

The controller 220 may be responsible for overall control of the portable terminal providing the convenience information and perform one or more operations of the matching information identification unit 211, the speech parsing unit 221, the data identification unit 223, the mapping data generation unit 225, the mapping data update unit 227, the object generation unit 229, the text dial view generation unit 231, and the view synthesis unit 223. FIG. 2 shows the foregoing components separately, which is for description to distinguish the operations thereof. However, aspects of the invention are not limited thereto, such that two or more of these units may be integrated together as a single unit. Thus, in practical products, the controller 210 may be configured to perform some or all operations of the foregoing components or only a portion of the operations thereof.

According to aspects of the invention, an automated voice prompt received from an ARS or the like during a call may be parsed into blocks of data, in which numerical values and/or words are identified and mapped for displaying the mapped word with the corresponding number key on a dial interface of the portable terminal.

The portable terminal providing the convenience information during a call according to exemplary embodiments of the invention may store existing incoming and outgoing call histories and details thereof, such as previously made menu selections during a call, in the database 240. Further, the portable terminal may display details of the mapping data stored in the database 240, which may correspond to a particular ARS having a phone number that was previously connected to with the portable terminal, on the dial pad. Accordingly, the user may verify or determine a button with displayed information and intuitively input an ARS button without listening to the entire ARS voice prompts.

According to aspects of the invention, a portable terminal providing the convenience information during a call may be used in connecting to an ARS system for performing various services, such as phone banking and/or home shopping, providing user convenience, and reducing an input time.

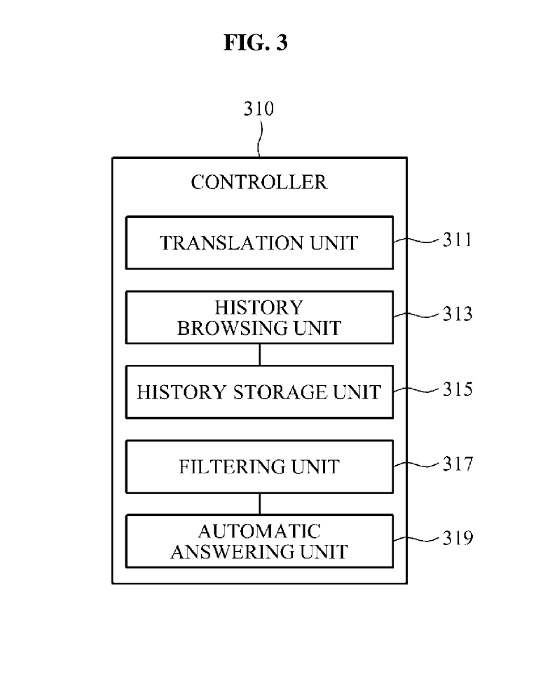

FIG. 3 illustrates a configuration of a controller of a portable terminal according to an exemplary embodiment of the present invention.

Referring to FIG. 3, controller 310 includes a translation unit 311, a history browsing unit 313, a history storage unit 315, a filtering unit 317, and an automatic answering unit 319.

The translation unit 311 may translate a word identified in mapping data into a foreign language based on a user input or vice-versa. The translation unit 311 may translate a first language, such as Korean, into a second language, such as English, or vice-versa. The word may be translated into a language selected by the user input among different languages. The translation unit 311 may operate, for example, in connection with a language translation application. A generally used language translation service or language translation application may be used in conjunction with the translation unit 311.

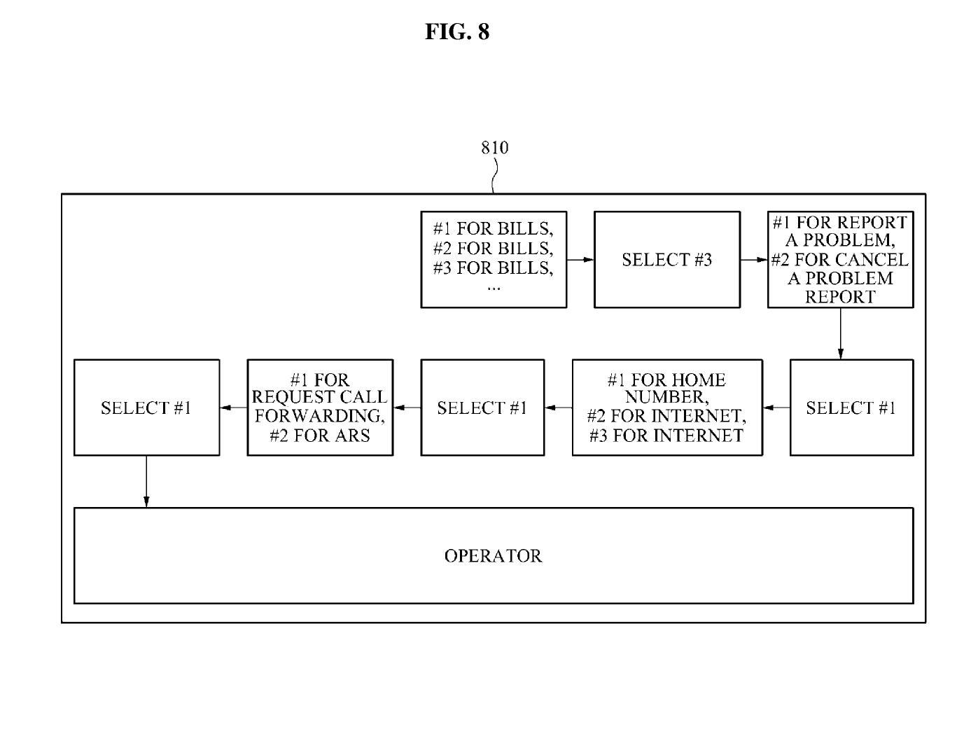

Further, the controller 310 may include a history storage unit 313 and a history browsing unit 315. The history storage unit 313 may store a history of an event according to an object ID previously selected by the user. For example, the history storage unit 313 may sequentially store information on selections made by the user from a menu of an ARS system. The history browsing unit 315 may browse the history of the previously selected event or menu options in response to a user request. The history may be stored in a database. For example, the history browsing unit 315 may load the history of the previously selected event from the database with respect to a menu of an ARS system having a telephone number selected by the user. The history browsing unit 315 may display the loaded history on the screen of the portable terminal. The history will be described in more detail with reference to FIG. 8.

Further, the controller 310 may include a filtering unit 317 and an automatic answering unit 319. The filtering unit 317 may filter an identified word when the word belongs to a preset keyword pool. The keyword pool may include a plurality of words set in advance. For example, the keyword pool may include a social security number, a phone number, and an address. The automatic answering unit 319 may provide an automated response with a preset operation corresponding to the filtered word. For example, when the social security number is filtered, the automatic answering unit 319 may load the social security number of the user of the portable terminal from the database and conduct automatic input of numbers on the dial pad corresponding to the social security number.

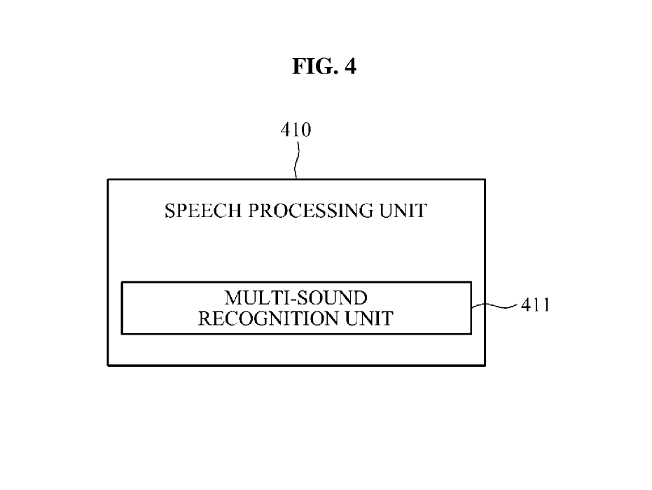

FIG. 4 illustrates a configuration of a speech processing unit of a portable terminal according to an exemplary embodiment of the present invention.

Referring to FIG. 4, speech processing unit 410 may include a multi-sound recognition unit 411. The multi-sound recognition unit 411 may identify that a sound or language perceived from an analog or automated sound is a foreign language and convert the identified foreign language into digital data. The multi-sound recognition unit 411 may convert the identified foreign language into a translated text data using an individual language speech recognition engine. The multi-sound recognition unit 411 may use a speech recognition engine generally used in the art.

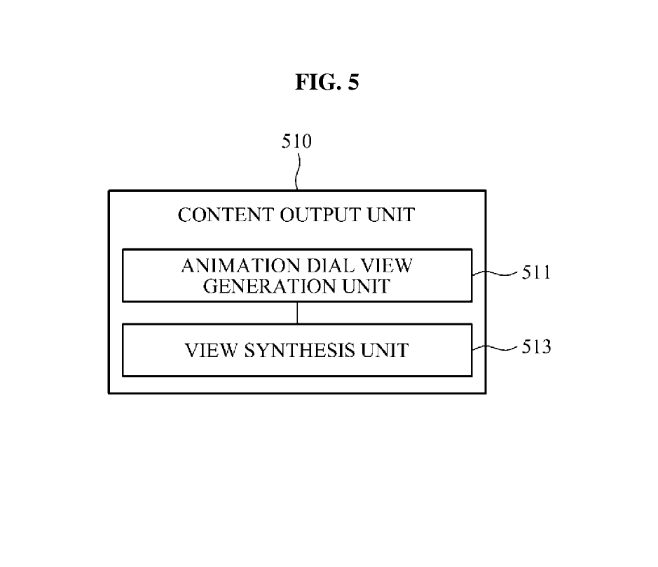

FIG. 5 illustrates a configuration of a content output unit of a portable terminal according to an exemplary embodiment of the present invention.

Referring to FIG. 5, content output unit 510 includes an animation dial view generation unit 511 and a view synthesis unit 513. The animation dial view generation unit 511 may generate an animated dial view such that an animation corresponding to an identified word is disposed on a number key on a dial screen. For example, when a word identified from a sound of an ARS system is “speak to operator,” the animation dial view generation unit 511 may generate a number key or a figure representing an operator. The animation dial view refers to a layer in which a word is expressed in an animation in an area where a number on a dial pad is displayed.

The view synthesis unit 513 may synthesize the dial screen and the animation dial view. The content output unit 510 may output or display a number key and an animation corresponding to the number key on the screen of the portable terminal.

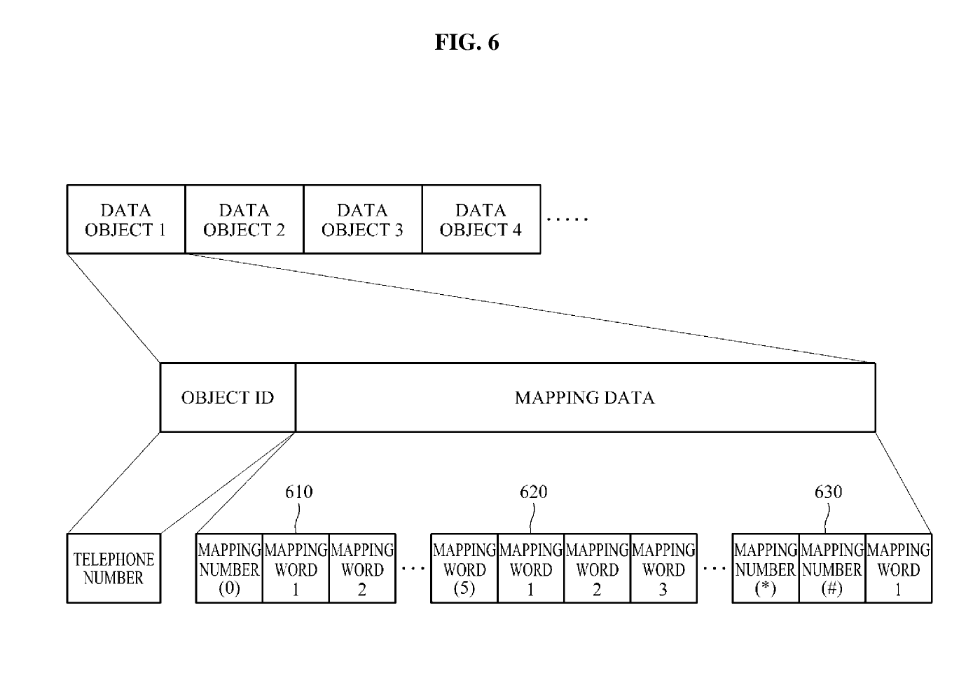

FIG. 6 illustrates a format of a data object according to an exemplary embodiment of the present invention.

Referring to FIG. 6, the data object may include an object ID field and a mapping data field. An object ID may be a telephone number or the like. When there is an object ID corresponding to a telephone number to which a call is made among the stored object IDs, relevant mapping data may be displayed on the screen of the portable terminal.

The mapping data may include a combination of a mapping number and a mapping word. For example, mapping data 610 of mapping number 0 corresponding to number key 0 on a dial interface of the portable terminal may have a structure including mapping word 1 and mapping word 2. For example, mapping word 1 may be “bill,” and mapping word 2 may be “inquiry.” Mapping data 620 of mapping number 5 corresponding to number key 5 on the dial is pad has a structure including mapping word 1, mapping word 2, and mapping word 3. For example, mapping word 1 may be “additional,” mapping word 2 may be “service,” and mapping word 3 may be “information.” Mapping data of mapping number * corresponding to a number key * on the dial pad has no mapping word. Mapping data 630 of mapping number # corresponding to number key # on the dial pad has a structure including mapping word 1 and mapping number #. Further, one or more sets of mapping words or phrases may correspond to a single mapping number. Different mapping words or phrases corresponding to a number key may be displayed based which menu prompt user interfaces with in a calling tree or menu path of the ARS.

The mapping number may include twelve numbers displayed on the dial pad including number keys, such as 0 to 9, * and #. A parsed word may be mapped onto a number, but a number neither parsed nor mapped may not be linked to a mapping word. One or more mapping words may be linked to a mapping number.

FIG. 7 illustrates information mapped onto a number key on a dial interface of a portable terminal according to an exemplary embodiment of the present invention.

Referring to FIG. 7, a Korean word may be identified by a multi-speech recognition engine from a sound received from the ARS system, and may be translated into an English equivalent, which may be displayed along with a number key on the dial pad. Similarly, when an English word is identified by the multi-speech recognition engine from the sound received from the ARS system, a Korean word may be displayed along with a number key on the dial pad according to user specified configurations.

FIG. 8 illustrates a menu selection history of previous selections made during a call according to an exemplary embodiment of the present invention.

Referring to FIG. 8, the portable terminal may generate a menu selection history 810 and store the menu selection history 810 in a database. The menu selection history 810 may include instructions or menu prompts of the ARS system as well as a user selection for that menu prompt. For example, information about a menu and a button selected by the user during the call may be stored in the database. FIG. 8 illustrates menus previously selected by the user, such as “to report a problem,” “to request repairs,” “home number,” “request call forwarding,” and “operator.”

The user may browse the menu selection history 810 stored in the database. The menu selection history 810 may be displayed on the screen of the portable terminal. Further, the menu selection history 810 may be displayed with respect to a calling tree of the ARS. The menu selection history 810 may be identified or stored according to a phone number.

The menu selection history 810 may be useful for a user to browse a record of responses to a particular ARS system later on. Further, when the user browses the menu selection history 810 and selects a final entry, or an intermittent entry in the call tree, of the menu selection history 810, the portable terminal may automatically selects menu option(s) that were previously selected by the user prior to arriving at the final entry or the selected intermittent entry, allowing the user to access the target menu option in the calling tree without having to make the selections to get to the selected entry. Referring to FIG. 8, when the user selects “operator” option in the menu selection history 810 during a call to the particular ARS system, the portable terminal may automatically input selections in the preceding stages and automatically connect to the “operator” menu option.

FIG. 9 illustrates a portable terminal receiving a sound and transmitting corresponding information according to an exemplary embodiment of the present invention.

Referring to FIG. 9, an input of a number on a dial pad may be processed by one or more macros. For instance, when the portable terminal receives a voice prompt 910 of “enter your social security number” in the voice prompt of the ARS and a word of “social security number”, which is identified, is stored in a keyword pool, the portable terminal may enable a social security number of the user to be automatically inputted. FIG. 9 illustrates an automatically inputted social security number on the dial pad 910.

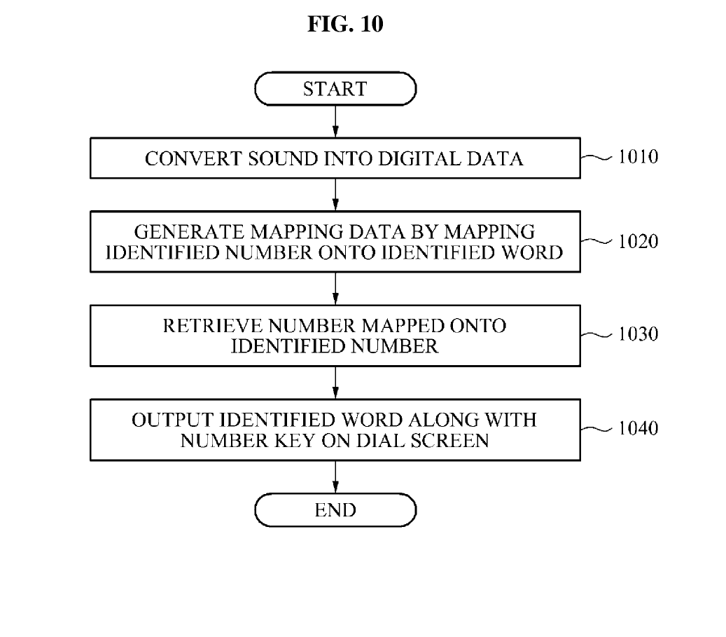

FIG. 10 is a flowchart illustrating a method for providing convenience information during a call in a portable terminal according to an exemplary embodiment of the present invention.

In operation 1010, the portable terminal may convert a sound received or perceived, such as an analog sound, into digital data. The portable terminal may parse the perceived sound into blocks of data. Here, a block may be set based on a segment of the sound. When the sound is not successively received for a preset time or is segmented by silence for a reference period of time, such a section may be defined as a single block. One or more blocks of data may be converted into digital data.

In operation 1020, the portable terminal may extract or identify a number value and/or a word or phrase from one or more blocks of data, and map the identified number to the word or phrase identified from the digital data for generating mapping data. The portable terminal may match the extracted number value to a number key on a dial pad via parsing. For example, the dial pad may include various number keys, such as 0 to 9, * and #. Further, the portable terminal may identify a word in one or more blocks of data via a parsing operation. The portable terminal may map the identified number value to the identified word. The portable terminal may generate mapping data by mapping a number value identified from a block of data to a word or phrase identified from the same block of data. However, aspects of the invention are not limited thereto, such that the number value and the word values are extracted or identified from different blocks of data, which may be ordered in a particular sequence or pattern.

In operation 1030, the portable terminal may retrieve a number value mapped onto the identified word from the mapping data.

In operation 1040, the portable terminal may output or display the identified word on or near a number key on the dial screen corresponding to the mapped number. The portable terminal may generate a text dial view to output or display the word mapped to the number value. The text dial view may refer to a layer in which a word is displayed as a text in an area where a number key of the dial screen is displayed (see FIG. 7). The portable terminal may synthesize a layer in which a number key is displayed and the text dial view so that the number and the word are displayed together on the dial screen.

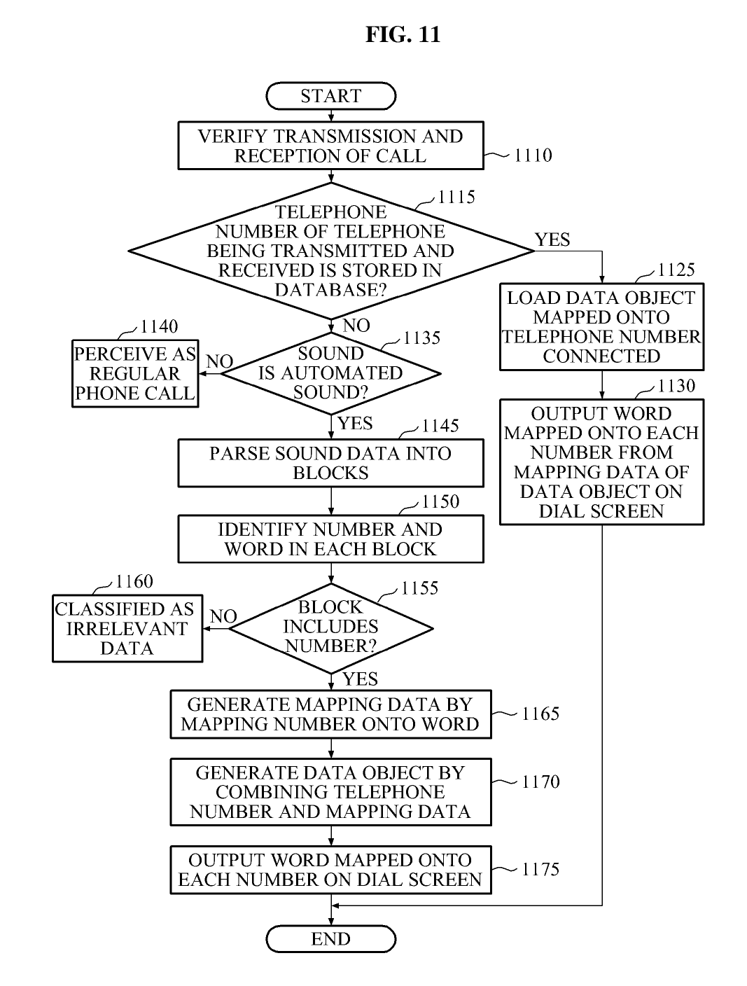

FIG. 11 is a flowchart illustrating a method for providing convenience information during a call in a portable terminal according to an exemplary embodiment of the present invention.

In operation 1110, the portable terminal may identify transmission and reception of a call. The portable terminal may verify whether a call operation of the telephone is activated.

In operation 1115, the portable terminal may determine whether a telephone number corresponding to a target party, to which a call is being transmitted and/or received, is stored in a database. The portable terminal may identify whether there is a telephone number matched with the telephone number being called is stored in the database.

In operation 1125, when the telephone number being dialed or called is determined to be stored in the database, the portable terminal may load a data object mapped to the telephone number to which the call is connected from the database. More specifically, the data object may be mapped to a particular telephone number corresponding to an ARS. Further, when a user calls the phone number associated with the stored data object, the stored data object may be loaded. Further, when mapping data of the data object is identified through a speech processing operation and determined that the mapping data corresponding to the particular telephone number has changed, the portable terminal may update the mapping information with the changed information.

In operation 1130, the portable terminal may output or display a word or a phrase mapped to a number value from the mapping data, which may be included in the loaded data object, on a dial screen.

In operation 1135, the portable terminal may verify or determine whether a received sound is an automated sound.

In operation 1140, when the received sound is determined not to be an automated sound, the portable terminal may receive or perceive the call as a regular phone call and perform a regular calling operation.

In operation 1145, when the received sound is identified as an automated sound, the portable terminal may parse sound data into blocks of data using a speech processing operation.

In operation 1150, the portable terminal may identify or extract a number value and a word included in one or more parsed blocks of data.

In operation 1155, the portable terminal may verify or determine whether a parsed block of data includes a number value.

In operation 1160, when the parsed block does not include a number value, the portable terminal may classify the block as irrelevant data.

In operation 1165, when the parsed block includes a number, the portable terminal may generate mapping data by mapping an identified or extracted number value to an identified word.

In operation 1170, the portable terminal may generate a data object by combining or associating the telephone number to which the call is connected and the mapping data.

In operation 1175, the portable terminal may output a word mapped to a number value on or near an area of a corresponding number key of the dial screen along with the number key.

According to aspects of the invention, a portable terminal may perceive or receive an analog or automated sound and convert the received sound into digital data. A number value and a word included in the digital data may be extracted or identified and may be displayed along with a corresponding number key of a dial interface of the portable terminal. Accordingly, convenience information corresponding to one or more number keys on a dial pad of a portable terminal may be displayed.

More specifically, aspects of the invention may provide a method of providing convenience information corresponding to one or more number keys on the dial pad of the portable terminal by generating mapping data via mapping an identified number to an identified word from an analog or automated sound and by using a data object, which may include the mapping data linked to a telephone number.

Further, aspects of the invention may convert an analog audio data into digital data. A number value and a word included in the digital data may be extracted or identified and may be displayed on the dial pad along with a number key, thereby improving usability and enabling intuitive processing to select target information from a displayed user interface without remembering all information that the user receives.

A method for providing convenience information during a call using a portable terminal according exemplary embodiments of the present invention may be recorded in non-transitory computer-readable media including program instructions to implement various operations embodied by a computer having a processor. The media may also include, alone or in combination with the program instructions, data files, data structures, and the like. The media and program instructions may be those specially designed and constructed for the purposes of the method for providing convenience information, or they may be of the kind well-known and available to those having skill in the computer software arts.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for providing information on a portable terminal, comprising:
establishing a connection with an automated response system (ARS);
receiving, from the ARS, a sound;
parsing the received sound into one or more blocks of data;
identifying a number value and a word from a block of data;
generating mapping data by mapping a number key of the portable terminal to the identified word based on the identified number value; and
outputting the mapped word with the corresponding number key on the portable terminal according to the mapping data.

2. The method of claim 1, further comprising:
generating a data object by mapping a telephone number of the ARS with the mapping data; and
storing the data object in a database.

3. The method of claim 2, wherein, if the portable terminal establishes a connection with the ARS for a second time, the data object corresponding to the telephone number is loaded for outputting the mapped word with the corresponding number key without processing the sound from the ARS.

4. The method of claim 1, further comprising:
converting the sound into digital data.

5. The method of claim 1, wherein the sound is parsed based on silent segments of a reference duration included in the sound.

6. The method of claim 2, wherein the data object includes at least one of an object data identifier (ID) and the mapping data corresponding to a particular telephone number.

7. The method of claim 1, further comprising:
storing menu options selected while the portable terminal is connected to the ARS as events in a menu selection history.

8. The method of claim 7, wherein, when an event is selected in the menu selection history, the menu option corresponding to the event and any preceding requisite menu options are automatically selected.

9. The method of claim 1, further comprising:
determining whether the identified word corresponds to a stored keyword,
wherein a preset operation is automatically executed if the identified word corresponds to the stored keyword.

10. The method of claim 1, further comprising:
converting the mapped word to a first language if the sound is provided in a second language.

11. The method of claim 1, further comprising:
identifying an animation corresponding to the mapped word; and
displaying the animation on the number key of the portable terminal.

12. A portable terminal, comprising:
a controller to establish a connection with an automated response system (ARS), and to receive a sound from the ARS;
a speech processing unit to parse the sound into one or more blocks of data, to identify a number value and a word from a block of data, and to generate mapping data by mapping a number key of the portable terminal to the identified word based on the identified number value; and
a content output unit to output the mapped word with the corresponding number key according to the mapping data.

13. The portable terminal of claim 12, further comprising:
a database unit to store a data object,
wherein the speech processing unit generates the data object by mapping a telephone number of the ARS with the mapping data.

14. The portable terminal of claim 13, wherein, if the portable terminal establishes a connection with the ARS for the second time, the controller determines that a data object corresponding to the ARA is available, controls the database to load the data object to output the mapped word with the corresponding number key, and inactivates the speech processing unit.

15. The portable terminal of claim 13, wherein the database further stores menu options selected while the portable terminal is connected to the ARS as events in a menu selection history, and
wherein the controller detects a selection of an event and automatically navigates to a selected event.

16. The portable terminal of claim 12, wherein the controller determines whether the identified word corresponds to a keyword stored in the database, and to automatically execute a preset operation if the identified word corresponds to the stored keyword.

17. The portable terminal of claim 12, wherein the speech processing unit converts the mapped word to a first language if the sound is provided in a second language.

18. The portable terminal of claim 12, wherein the content output unit identifies an animation corresponding to the mapped word, and displays the animation on the number key.

19. A method for providing convenience information on a portable terminal, comprising:
establishing a connection with an automated response system (ARS) having a telephone number;
determining whether a data object corresponding to the telephone number is stored in a database; and
loading the data object for outputting a text of a menu option mapped to a number key of the portable terminal,
wherein the data object comprises mapping information of the menu option provided in the ARS with the number key.

20. The method of claim 19, further comprising:
determining whether menu options in the ARS has changed; and
updating the data object to reflect the changed information.
